(19) United States
(12) Patent Application Publication
(10) Pub. No.: US 2011/0157584 A1
(43) Pub. Date: Jun. 30, 2011

(54) METHOD OF CALIBRATING A LIGHT SOURCE

(75) Inventors: Chia-Fan LIN, Taipei (TW); Yi-Jian LEE, Taipei (TW)

(73) Assignee: ABILITY ENTERPRISE CO., LTD., TAIPEI (TW)

(21) Appl. No.: 12/774,368

(22) Filed: May 5, 2010

(30) Foreign Application Priority Data
Dec. 25, 2009 (TW) 098145060

(51) Int. Cl. G01J 1/10

(52) U.S. Cl. 356/243.1

(57) ABSTRACT

The present invention is directed to a method of calibrating a light source. In one embodiment, a standard image sensor is used to capture emitted light of a standard and a to-be-calibrated light source in order to obtain a standard and a nonstandard image, respectively. A standard and a nonstandard luminance response are generated according to the standard and the nonstandard image, respectively. The to-be-calibrated light source is adjusted until the nonstandard luminance response is about equal to the standard luminance response. In another embodiment, the standard image sensor is used to capture emitted light of the standard and the to-be-calibrated light source. According to sampled outputs of the standard image sensor, a standard and a nonstandard chrominance response are respectively generated, which are used to compensate an image sensor under test.

### CROSS-REFERENCE TO RELATED APPLICATIONS

The entire contents of Taiwan Patent Application No. 098145060, filed on Dec. 25, 2009, from which this application claims priority, are incorporated herein by reference.

### BACKGROUND OF THE INVENTION

1. Field of the Invention

The present invention generally relates to an image sensor, and more particularly to a method of calibrating a light source.

2. Description of Related Art

A standard light source must be used to inspect the digital cameras for ensuring that the digital cameras could meet the quality requirement when leaving the factory. However, the price and maintenance costs of a real standard light source are very high, and its calibration procedure is very complicated and time-consuming, therefore usually resulting in reduction in production efficiency.

Furthermore, multi-production lines are typically used to inspect the digital cameras simultaneously. Since the light spectrum of each nonstandard light source is different, the luminance obtained by the image sensor (such as charge-coupled device (CCD)) of the digital camera and the response of sensing each color are different. When the diversity of every image sensor of the digital camera is also concerned, the inspection procedure will become difficult to control, and therefore can not ensure the stability of products.

A need has thus arisen to propose a novel method of calibrating a light source with simple operations for providing the calibrated standard light source, in order to facilitate the inspection of the digital cameras.

### SUMMARY OF THE INVENTION

The embodiments of the present invention disclose a method of calibrating a light source to reduce the difference among various light sources, so as to facilitate the inspection of the image sensor-related products, thereby maintaining the stability of product quality.

According to one embodiment of the present invention, a standard image sensor is used to capture emitted light of a standard and a to-be-calibrated light source in order to obtain a standard and a nonstandard image, respectively. A standard and a nonstandard luminance response are generated according to the standard and the nonstandard image, respectively. Compare the standard luminance response with the nonstandard luminance response. If they are different, the to-be-calibrated light source is adjusted until the nonstandard luminance response is about equal to the standard luminance response.

According to another embodiment of the present invention, the standard image sensor is used to capture emitted light of the standard and the to-be-calibrated light source, respectively. According to sampled outputs of the standard image sensor, a standard and a nonstandard chrominance response are generated, respectively. The standard chrominance response is recorded in a profile. Then, the to-be-calibrated light source is used to inspect an image sensor under test, thereby obtaining the inspection result, which is compensated according to the profile.

### BRIEF DESCRIPTION OF THE DRAWINGS

FIG. 1 shows a flow diagram that illustrates a method of calibrating a light source according to one embodiment of the present invention; and

FIG. 2 exemplifies the chrominance responses of the sampled outputs of three colors, red (R), green (G) and blue (B).

### DETAILED DESCRIPTION OF THE INVENTION

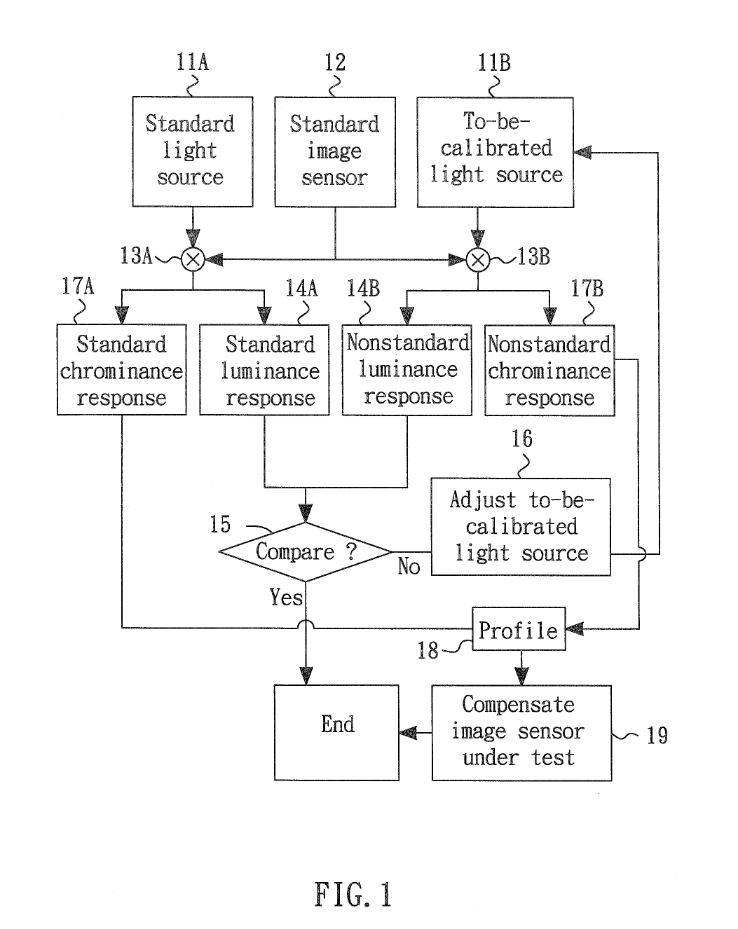

FIG. 1 shows a flow diagram that illustrates a method of calibrating a light source according to one embodiment of the present invention. In the embodiment, a standard light source such as a standard light box is provided in step 11A firstly. The standard light source may be, but not limited to, the Commission internationale de l'éclairage (CIE) standard light source. For example, the standard light source series “D” of CIE standard represents the daylight.

In step 12, a standard image sensor or a standard digital camera (or a standard digital camcorder with the standard image sensor) is provided. It may be called a golden sample in the embodiment, which is generally referred to a standard sample that has been designed, tested and revised before mass production. The image sensor may be, but not limited to, a charge coupled device (CCD) or a complementary metal oxide semiconductor (CMOS) image sensor.

Subsequently, in step 13A, the standard image sensor (such as a standard digital camera) is used to capture the emitted light of the standard light source. According to the present step, a standard image or a picture is obtained. Then, in step 14A, a standard luminance response is generated according to the standard image. Specifically, in the embodiment, the standard image is analyzed and calculated within the visible light frequency or wavelength range (e.g., 380-730 nanometers (nm)) to obtain an integration value or the intensity of the standard image, which is then used as the standard luminance response. The above operation may be, but not limited to, convolution integration, which can be executed by a digital signal processor (DSP) contained in the standard digital camera, or by external hardware and/or software.

On the other hand, at least a to-be-calibrated light source or a light box is provided in step 11B, and the standard image sensor (or the standard digital camera) is used to capture emitted light of the to-be-calibrated light source (step 13B). In the embodiment, the to-be-calibrated light source and the standard light source are located at different sites. For example, the standard light source is located at a laboratory, but the to-be-calibrated light source is located at a mass-production line region.

According to the step, a nonstandard image or picture may be obtained. Subsequently, in step 14B, a nonstandard luminance response is generated according to the nonstandard image. Being similar to the situation in step 14A, the nonstandard image is analyzed and calculated within the visible light frequency or wavelength range (e.g., 380-730 nanometers (nm)) to obtain an integration value or the intensity of the nonstandard image, which is then used as the nonstandard luminance response.

Subsequently, in step 15, comparing the standard luminance response with the nonstandard luminance response to determine whether they are equivalent or not. If they are different, for example, the difference between the intensity of both is greater than a predetermined threshold value, then the to-be-calibrated light source is adjusted until the nonstandard luminance response is about equal to the standard luminance response, that is, until the nonstandard luminance response is equal to the standard luminance response or until the difference between the intensity of both is less than the predetermined threshold value (step 16).

According to the above embodiment, it may perform calibration on the to-be-calibrated light source by using the standard image sensor and its standard luminance response, thereby controlling and ensuring the stability of the image sensors (such as digital cameras) under test among mass-production lines quality. Furthermore, it may also reduce the cost of purchasing expensive standard light sources on production lines, and the complicated and time-consuming calibration procedures, therefore increasing the production efficiency.

The above embodiment can perform the luminance response calibration on the to-be-calibrated light source, while performing the chrominance response calibration on the to-be-calibrated light source is disclosed in the following embodiment, which may be additionally or independently performed.

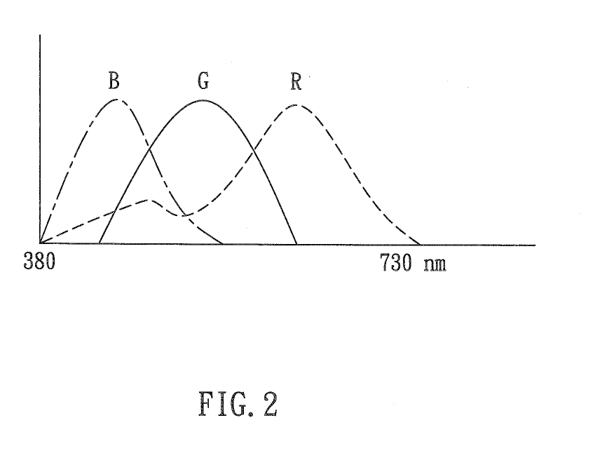

In the embodiment, after capturing emitted light of the standard light source by the standard image sensor (such as standard digital camera) in step 13A, the output of the standard image sensor is sampled to generate a standard chrominance response in step 17A. Specifically, sampled outputs of the standard image sensor typically include sampled outputs with some colors (e.g., red (R), green (G), blue (B)), and the sensed outputs are generally not the same among the colors. FIG. 2 exemplifies the chrominance responses of the sampled outputs of the three colors, red (R), green (G) and blue (B).

Subsequently, one of the color-sensed outputs is taken as the benchmark-sensed output (e.g., integration value of the green-sensed output), and the ratios of other color-sensed outputs to the benchmark-sensed output are obtained as standard ratios, for example, the standard ratio of red to green (R/G) and the standard ratio of blue to green (B/G). The standard ratios may be recorded in a profile (step 18). In the embodiment, the standard ratios are recorded in the standard digital camera.

On the other hand, for example, on the production line side, after capturing emitted light of the to-be-calibrated light source by the standard image sensor (such as standard digital camera) in step 13B, then, the output of the standard image sensor is sampled to generate a nonstandard color chrominance response in step 17B. The nonstandard color chrominance response is similar to, but usually somewhat different from the chrominance responses of the sampled outputs of the three colors, red (R), green (G) and blue (B) exemplified in FIG. 2.

Subsequently, one of the color-sensed outputs is taken as the benchmark-sensed output (e.g., integration value of the green-sensed output), and the ratios of other color-sensed outputs to the benchmark-sensed output are obtained as standard ratios, for example, the standard ratio of red to green (R/G) and the standard ratio of blue to green (B/G).

Finally, in step 19, when the to-be-calibrated light source is used to inspect an image sensor under test, the inspection result of the image sensor under test is compensated according to the standard ratios in the profile and comparison with the nonstandard ratio of the image sensor under test.

Although specific embodiments have been illustrated and described, it will be appreciated by those skilled in the art that various modifications may be made without departing from the scope of the present invention, which is intended to be limited solely by the appended claims.

What is claimed is:

1. A method of calibrating a light source, comprising:
providing a standard light source and a standard image sensor;
capturing emitted light of the standard light source by the standard image sensor to obtain a standard image;
generating a standard luminance response according to the standard image;
capturing emitted light of a to-be-calibrated light source by the standard image sensor to obtain a nonstandard image;
generating a nonstandard luminance response according to the nonstandard image;
comparing the standard luminance response with the nonstandard luminance response; and
adjusting the to-be-calibrated light source until the nonstandard luminance response is equal to the standard luminance response, if the nonstandard luminance response differs from the standard luminance response.

2. The method of claim 1, wherein the standard luminance response is intensity of the standard image, and the nonstandard luminance response is intensity of the nonstandard image.

3. The method of claim 2, wherein the intensity of the standard image is an integration value of the standard image within a visible light frequency range, and the intensity of the nonstandard image is an integration value of the nonstandard image within the visible light frequency range.

4. The method of claim 1, wherein the standard image sensor is a standard digital camera.

5. A method of calibrating a light source, comprising:
providing a standard light source and a standard image sensor;
capturing emitted light of the standard light source by the standard image sensor;
sampling outputs of the standard image sensor to generate a standard chrominance response;
capturing emitted light of a to-be-calibrated light source by the standard image sensor; and
sampling outputs of the standard image sensor to generate a nonstandard chrominance response.

6. The method of claim 5, after generating the standard chrominance response, further comprising:
recording the standard chrominance response in a profile.

7. The method of claim 6, after generating the nonstandard chrominance response, further comprising:
inspecting an image sensor under test by the to-be-calibrated light source to obtain an inspection result; and
compensating the inspection result according to the standard and the nonstandard chrominance responses.

8. The method of claim 7, wherein the standard image sensor is a standard digital camera, and the image sensor under test is a digital camera under test.

9. The method of claim 6, wherein the sampled outputs of the standard image sensor include sampled outputs of a plurality of colors, and the sampled outputs of the nonstandard image sensor include sampled outputs of a plurality of colors.

10. The method of claim 9, wherein the plurality of colors include red (R), green (G) and blue (B).

11. The method of claim 9, wherein the standard chrominance response includes standard ratios among the sampled outputs of the colors, and the nonstandard chrominance response includes nonstandard ratios among the sampled outputs of the colors.

12. The method of claim 11, wherein one of the sampled outputs of the colors is taken as a benchmark-sensed output, the ratios of the sampled outputs of other colors to the benchmark-sensed output are the standard ratios and the nonstandard ratios in corresponding to the standard chrominance response and the nonstandard chrominance response, respectively.

13. A method of calibrating a light source, comprising the following steps performed not in the sequence set forth:
providing a standard light source and a standard image sensor;
capturing emitted light of the standard light source by the standard image sensor to obtain a standard image;
generating a standard luminance response according to the standard image;
sampling outputs of the standard image sensor to generate a standard chrominance response;
capturing emitted light of a to-be-calibrated light source by the standard image sensor to obtain a nonstandard image;
generating a nonstandard luminance response according to the nonstandard image;
sampling outputs of the standard image sensor to generate a nonstandard chrominance response;
comparing the standard luminance response with the nonstandard luminance response;
adjusting the to-be-calibrated light source until the nonstandard luminance response is equal to the standard luminance response, if the nonstandard luminance response differs from the standard luminance response;
recording the standard chrominance response in a profile;
inspecting an image sensor under test by the to-be-calibrated light source to obtain an inspection result; and
compensating the inspection result according to the profile.

14. The method of claim 13, wherein the standard luminance response is intensity of the standard image, and the nonstandard luminance response is intensity of the nonstandard image intensity.

15. The method of claim 14, wherein the intensity of the standard image is an integration value of the standard image within a visible light frequency range, and the intensity of the nonstandard image is an integration value of the nonstandard image within the visible light frequency range.

16. The method of claim 13, wherein the standard image sensor is a standard digital camera, and the image sensor under test is a digital camera under test.

17. The method of claim 13, wherein the sampled outputs of the standard image sensor include sampled outputs of a plurality of colors, and the sampled outputs of the nonstandard image sensor include sampled outputs of a plurality of colors.

18. The method of claim 17, wherein the plurality of colors include red (R), green (G) and blue (B).

19. The method of claim 17, wherein the standard chrominance response includes standard ratios among the sampled outputs of the colors, and the nonstandard chrominance response includes nonstandard ratios among the sampled outputs of the colors.

20. The method of claim 19, wherein one of the sampled outputs of the colors is taken as a benchmark-sensed output, the ratios of the sampled outputs of other colors to the benchmark-sensed output are the standard ratios and the nonstandard ratios in corresponding to the standard chrominance response and the nonstandard chrominance response, respectively.
